(19) United States
(12) Patent Application Publication
(10) Pub. No.: US 2008/0126577 A1
(43) Pub. Date: May 29, 2008

(54) METHOD FOR MANAGING ADDRESS AND VIDEO APPARATUS USING THE SAME

(75) Inventors: Dae-gyu Bae, Suwon-si (KR); Jin-woo Hong, Suwon-si (KR); Dong-young Kim, Seongnam-si (KR); Ho-jeong You, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/932,016

(22) Filed: Oct. 31, 2007

Related U.S. Application Data
(60) Provisional application No. 60/861,102, filed on Nov. 27, 2006.

(30) Foreign Application Priority Data
May 1, 2007 (KR) 10-2007-0042342

(51) Int. Cl. G06F 3/00

(52) U.S. Cl. 710/4

(57) ABSTRACT

A method for managing an address and a video apparatus using the same are provided. The method for managing an address includes acquiring an address of the apparatus, and determining whether or not the acquired address and an address of one of the external apparatuses collide if a command for resetting an address is received from another one of external apparatuses. As a result, collision of addresses between apparatuses may be prevented.

### CROSS-REFERENCE TO RELATED APPLICATIONS

This application claims benefit from U.S. Provisional Application No. 60/861,102 filed on Nov. 27, 2006 and priority from Korean Patent Application No. 10-2007-0042342, filed on May 1, 2007, in the Korean Intellectual Property Office, the disclosures of which are incorporated herein by reference in their entirety.

### BACKGROUND OF THE INVENTION

1. Field of the Invention

Methods and apparatuses consistent with the present invention relate to a method for managing an address and a video apparatus using the same, and more particularly, to a method for managing an address to prevent collision of addresses between video apparatuses connected with each other and a video apparatus using the same.

2. Description of the Related Art

FIG. 1 is a view illustrating a video system of which components are connected according to High Definition Multimedia Interface Consumer Electronics Control (HDMI CEC) standard. That is, the video system of FIG. 1 includes a digital television (DTV) 10 and AV apparatuses 20-1, 20-2 which are connected with each other according to HDMI CEC standard.

A control signal in addition to a video signal is transmitted and received between a DTV 10 and AV apparatuses 20-1, 20-2, and each apparatus should have a logical address.

However, the two AV apparatuses 20-1, 20-2 can have the same logical address, in which case the addresses collide. For example, when the first AV apparatus 20-1 is connected to the DTV 10, an address “01” is assigned to the first AV apparatus 20-1. Then when the first AV apparatus 20-1 enters a power save mode, the second AV apparatus 20-2 may be connected to the DTV 10, and sequentially assigned the same address as that of the first AV apparatus 20-1. As a result, the addresses collide. As the first AV apparatus 20-1 entering a power save mode does not recognize that the second AV apparatus 20-2 is connected to the DTV 10, the first AV apparatus 20-1 cannot prevent the same address “01” as that of the first AV apparatus 20-1 from being assigned to the second AV apparatus 20-2.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An exemplary aspect of the present invention provides a method for managing an address to prevent collision of addresses between AV apparatuses caused in a case when an AV apparatus connected to an apparatus enters a power save mode, and another AV apparatus is connected to the AV apparatus, and a video apparatus using the same.

According to an aspect of the present invention, there is provided a method for managing an address of an apparatus that comprises acquiring an address of the apparatus; and determining whether or not the acquired address of the apparatus and an address of a first one of external apparatuses collide if a command for resetting an address is received from a second one of the external apparatuses.

The method may further comprise changing the acquired address of the apparatus if an external apparatus using the same address as the acquired address among the external apparatuses is searched.

The command for resetting an address may comprise a command for determining whether or not the acquired address is used by any one of the external apparatuses.

The command for resetting an address may comprise information regarding a reason for performing the address reset.

The address may comprise a logical address.

The external apparatuses may be connected according to High Definition Multimedia Interface Consumer Electronics Control (HDMI CEC) standard.

According to another aspect of the present invention, there is provided a video apparatus that comprises an interface which is connected for communication with external apparatuses; and a control unit which acquires its own address, and searches an external apparatus using the same address as the acquired address among the external apparatuses through the interface if a command for resetting an address is received from one of the external apparatuses through the interface.

According to another aspect of the present invention, there is provided a method for managing an address that comprises transmitting a command for resetting an address to external apparatuses; and discovering addresses of the external apparatuses after a predetermined time lapses after the transmitting of the command for resetting an address.

The command for resetting an address may comprise a command for determining whether an address allocated to one of the external apparatuses is used by another one of the external apparatuses.

The command for resetting an address may comprise information regarding a reason for performing the address reset.

The address may comprise a logical address.

The transmitting may comprise broadcasting the command for resetting an address.

The t external apparatuses may be connected according to High Definition Multimedia Interface Consumer Electronics Control (HDMI CEC) standard.

According to another aspect of the present invention, there is provided a video apparatus that comprises an interface which is connected for communication with external apparatuses; and a control unit which transmits a command for resetting an address to the external apparatuses through the interface, and discovers addresses of the external apparatuses through the interface after a predetermined time lapses after transmitting the command for resetting an address.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view illustrating a video system of which components are connected according to a High Definition Multimedia Interface Consumer Electronics Control (HDMI CEC) standard;

FIG. 2 is a block diagram illustrating a video system according to an exemplary embodiment of the present invention;

FIG. 3 is a flowchart illustrating a method for managing an address according to an exemplary embodiment of the present invention;

FIG. 4 is a view illustrating structure of a command for resetting a logical address;

FIG. 5 is a block diagram illustrating a video apparatus according to another exemplary embodiment of the present invention;

FIG. 6 is a flowchart illustrating a method for managing an address according to another exemplary embodiment of the present invention;

FIG. 7 is a block diagram illustrating a video apparatus according to yet another exemplary embodiment of the present invention; and

FIG. 8 is a flowchart illustrating a method for managing an address according to yet another exemplary embodiment of the present invention.

### DETAILED DESCRIPTION OF THE EXEMPLARY EMBODIMENTS

Certain exemplary embodiments of the present invention will now be described in greater detail with reference to the accompanying drawings.

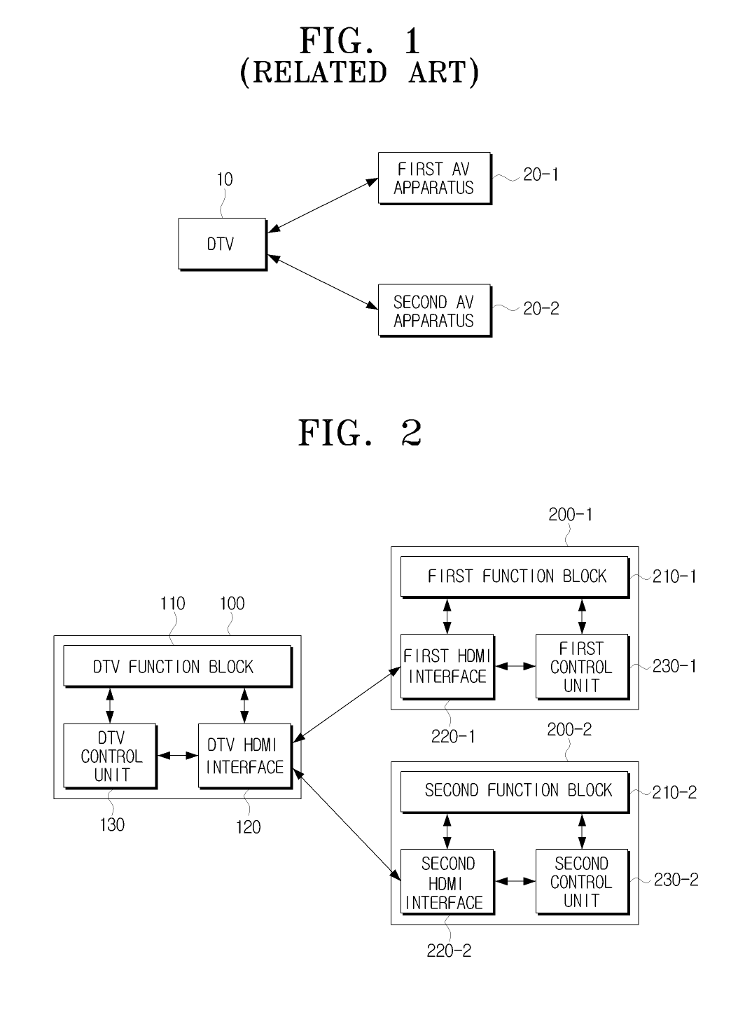

FIG. 2 is a block diagram illustrating a video system according to an exemplary embodiment of the present invention. A video system of FIG. 2 includes a digital television (DTV), first and second AV apparatuses 200-1, 200-2 which are connected and configured according to a High Definition Multimedia Interface Consumer Electronics Control (HDMI CEC) standard.

Referring to FIG. 2, the digital television (DTV) 100 may comprise a DTV function block 110, a DTV HDMI interface 120, and a DTV control unit 130.

The DTV function block 110 performs basic functions of a DTV. Specifically, the DTV function block 110 performs a signal processing such as decoding and scaling of a broadcasting signal which is received from a broadcast station over wire or wirelessly, and provides broadcast contents to a user by displaying the broadcast contents on a display. Additionally, the DTV function block 110 may display a video image corresponding to a video signal transmitted from the first and second AV apparatuses 200-1, 200-2 through the DTV HDMI interface 120 which will be explained below.

The DTV HDMI interface 120 is connected with the first and second AV apparatuses 200-1, 200-2 according to the HDMI CEC standard to transmit and receive a video signal and a message between the DTV 100 and the first and second AV apparatuses 200-1, 200-2.

The DTV control unit 130 controls the operations of the DTV function block 110 according to a user command. The DTV control unit 130 transmits a control command to the first and second AV apparatuses 200-1, 200-2 through the DTV interface 120 to control the first and second AV apparatuses 200-1, 200-2.

The DTV control unit 130 discovers the first and second AV apparatuses 200-1, 200-2, and acquires a logical address of each of the first and second AV apparatuses 200-1, 200-2.

The DTV control unit 130 broadcasts a command for resetting an address to command the first and second AV apparatuses 200-1, 200-2 to check their own logical addresses.

The DTV control unit 130 performs discovery after a predetermined time lapses after the command for resetting an address is transmitted. The DTV control unit 130 waits for the predetermined time after the transmission of the command for resetting an address, so that the AV apparatuses 200-1, 200-2 can secure time required to check their logical addresses and change the addresses when a problem occurs.

Referring to FIG. 2, the first AV apparatus 200-1 may comprise a first function block 210-1, a first HDMI interface 220-1, and a first control unit 230-1.

The first function block 210-1 performs basic functions of an AV apparatus. That is, the first function block 210-1 operates to read a video signal from a recording medium, and provides the read video signal to the DTV 100 through the first HDMI interface 220-1 which will be explained below.

The first HDMI interface 220-1 is connected to the DTV 100 and the second AV apparatus 200-2 according to the HDMI CEC standard such that a video signal and a message may be transmitted and received to and from the DTV 100 or between the first AV apparatus 200-1 and the second AV apparatus 200-2.

The first control unit 230-1 controls the operation of the first function block 210-1 according to a control command of the DTV control unit 130 which is transmitted through the first HDMI interface 220-1. When the first AV apparatus 200-1 is connected to the DTV 100, the first control unit 230-1 acquires a logical address of the first control unit 230-1 using the first HDMI interface 220-1.

When the first control unit 230-1 receives a command for resetting an address from the DTV control unit 130 through the DTV HDMI interface 120 and the first HDMI interface 220-1, the first control unit 230-1 checks the logical address of the first control unit 230-1, and if a problem such as an address collision occurs, the first control unit 230-1 changes the logical address of the first control unit 230-1.

The structure and operation of the second AV apparatus 200-2, including the second function block 210-2, the second HDMI interface 220-2, and the second control unit 230-2, are substantially the same as those of the first AV apparatus 200-1, including the first function block 210-1, the first HDMI interface 220-1, and the first control unit 230-1, and thus a description thereof will be omitted for the sake of brevity.

A process of managing a logical address of each of AV apparatuses in a video system of FIG. 2 will be explained in detail with reference to FIG. 3.

Referring to FIG. 3, the first control unit 230-1 of the first AV apparatus 200-1 acquires a logical address of the first control unit 230-1 by broadcasting a packet inter-network groper (ping) to the AV apparatuses which are connected to the DTV 100 at operation S310.

As the second AV apparatus 200-2 is the only AV apparatus that is connected to the DTV 10 besides the first AV apparatus 200-1 in an exemplary embodiment of the present invention, the second AV apparatus 200-2 receives the ping broadcast by the first control unit 230-1. If other AV apparatuses other than the second AV apparatus 200-2 are connected to the DTV 100, the ping broadcast by the first control unit 230-1 may be received by the other AV apparatuses too.

A logical address to be used by the first AV apparatus 200-1 is recorded in the ping broadcast by the first control unit 230-1 at operation S310.

The second AV apparatus 200-2 receiving a ping discards the received ping if a logical address recorded in the received ping differs from a logical address of the second AV apparatus 200-2. In this case, the first AV apparatus 200-1 does not receive an acknowledgement after broadcasting the ping. If the first AV apparatus 200-1 does not receive an acknowledgement within a predetermined time after broadcasting the ping, the first AV apparatus 200-1 sets the logical address recorded in the broadcast ping as a logical address of the first AV apparatus 200-1.

If the address recorded in the received ping is the same as that of the second AV apparatus 200-2, the second AV apparatus 200-2 receiving the ping transmits an acknowledgement to the first AV apparatus 200-1. The first AV apparatus 200-1 receiving the acknowledgement broadcasts a ping having a different address to the second AV apparatus, and checks whether or not an acknowledgement is received. The operation may be reiterated until the first AV apparatus 200-1 acquires its own logical address.

The second control unit 230-2 in the second AV apparatus 200-2 acquires its own logical address through the process of broadcasting a ping to the AV apparatuses which are connected to the DTV 100 at operation S320.

The operation S320 is substantially the same as the operation S310, and thus a description thereof will be omitted for the sake of brevity. The order of the operations S310 and S320 may be reversed.

If a user inputs a command for power-on or discovery at operation S330, the DTV control unit 130 in the DTV 100 broadcasts a command for resetting a logical address to the first and second AV apparatuses 200-1, 200-2 which are connected thorough the DTV HDMI interface 120 at operation S340.

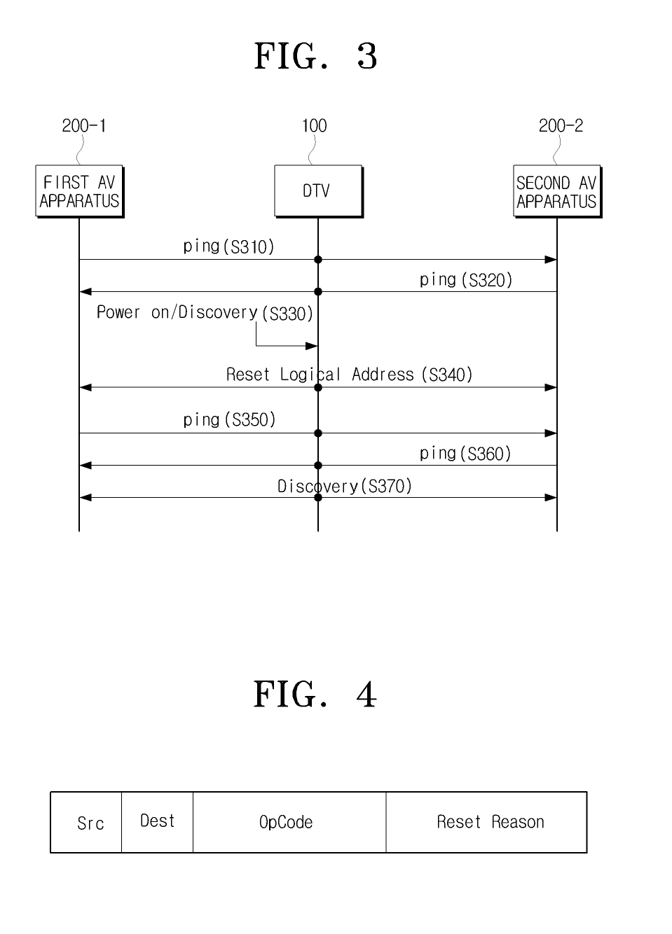

FIG. 4 is a view illustrating structure of a command for resetting a logical address. Referring to FIG. 4, the command for resetting a logical address comprises a field “Src” in which a source address is recorded, a field “Dest” in which a destination address is recorded, a field “OpCode”, and a field “Reset Reason”.

Since a source of a command for resetting a logical address is the DTV 100 at operation S340, an address of the DTV 100 is recorded in the field “Src”. Since the command for resetting a logical address is broadcast, a code indicating a broadcast is recorded in the field “Dest”.

A code indicating a command for checking its own logical address is recorded in the filed “OpCode”. Accordingly, a message including the field “OpCode” having the code recorded may be the command for resetting a logical address.

Reason for performing the logical address reset is recorded in the field “Reset Reason”. For example, a code indicating power-on or discovery may be recorded in the field “Reset Reason” as the reason for performing the logical address reset.

The first control unit 230-1 in the first AV apparatus 200-1 which receives the command for resetting the broadcast logical address checks its own logical address through the process of broadcasting a ping to the AV apparatuses which are connected to the DTV 100 at operation S350.

Particularly, the first control unit 230-1 checks whether a logical address currently used in the first AV apparatus 200-1 is used in the other AV apparatuses (the second AV apparatus 200-2 in the exemplary embodiment) to determine the occurrence of the collision between the logical addresses at operation S350. To do this, the first control unit 230-1 broadcasts a ping having its current logical address to the other AV apparatuses.

The second AV apparatus 200-2 receiving the ping discards the received ping, if the logical address recorded in the received ping differs from its own logical address. In this case, the first AV apparatus 200-1 does not receive any acknowledgement after broadcasting the ping. If a message is not received within a predetermined time after broadcasting the ping, the first AV apparatus 200-1 determines that its current logical address does not collide with the address of the second AV apparatus 200-2. As a result, the first AV apparatus 200-1 uses its own logical address without changing it.

If the logical address of the second AV apparatus 200-2 is the same as the logical address in the ping, the second AV apparatus 200-2 receiving the ping transmits to the first AV apparatus 200-1 a message informing the fact that its own logical address is the same as the logical address recorded in the received ping. The first AV apparatus 200-1, on receiving the message, broadcasts a ping having a different address to the connected AV apparatuses, to change its logical address. The operation may be reiterated until the first AV apparatus acquires its logical address.

The second control unit 230-2 in the second AV apparatus 200-2 receiving the command for resetting the logical address checks its own logical address through the process of broadcasting a ping to the AV apparatuses which are connected to the DTV 100 at operation S360.

The operation S360 is substantially the same as that of S350, and thus a description thereof will be omitted for the sake of brevity. The order of the operations S350 and S360 may be reversed.

If a predetermined time is passed after the command for resetting the logical address is broadcast, the DTV control unit 130 in the DTV 100 discovers the logical addresses of the first and second AV apparatuses 200-1, 200-2, respectively, and acquires the logical addresses of the connected first and second AV apparatuses 200-1, 200-2 at operation S370.

A process of managing a logical address of each of AV apparatuses in the video system illustrated in FIG. 2 has been described according to an exemplary embodiment of the present invention.

In an exemplary embodiment of the present invention, if a user inputs a command for power-on or discovery, a command for resetting a logical address may be broadcast from a DTV to AV apparatuses, but it is merely for the purpose of illustrating an exemplary embodiment of the present invention. Alternatively, the command for resetting a logical address may be broadcast from a DTV to AV apparatuses according to a predetermined cycle or condition without using a user command.

For example, it may be implemented to broadcast a command for resetting a logical address from a DTV to AV apparatuses at regular intervals, or to broadcast a command for resetting a logical address from a DTV to AV apparatuses in response to a connection of a new AV apparatus to the DTV.

An address managed in an exemplary embodiment of the present invention is a logical address, but other types of an address are applicable to the present invention.

As the field “Reset Reason” is not required necessarily in the command for resetting the logical address illustrated in FIG. 4, the field “Reset Reason” may be omitted from the command for resetting the logical address.

The command for resetting the logical address is not limited to construction as illustrated in FIG. 4, and other construction may be implemented. For example, a command for resetting a logical address may be implemented using a Vendor Command.

The video system using one DTV and two AV apparatuses is constructed in an exemplary embodiment of the present invention, but it is merely for the purpose of illustrating an exemplary embodiment of the present invention. The number of the DTVs and the AV apparatuses may be changed as necessary.

A video apparatus may be used instead of the DTV to constitute the video system in an exemplary embodiment of the present invention. The AV apparatus provided in an exemplary embodiment of the present invention is described as an AV apparatus to reproduce a video signal recorded in a recording medium, but the video system may be implemented as an AV apparatus having a different operation.

The video apparatuses constructing the video system are connected with each other according to the HDMI CEC standard in an exemplary embodiment of the present invention, but it is also merely for the purpose of illustrating an exemplary embodiment of the present invention. Any method of transmitting and receiving a message between video apparatuses may be applicable to the present invention instead of the HDMI CEC standard.

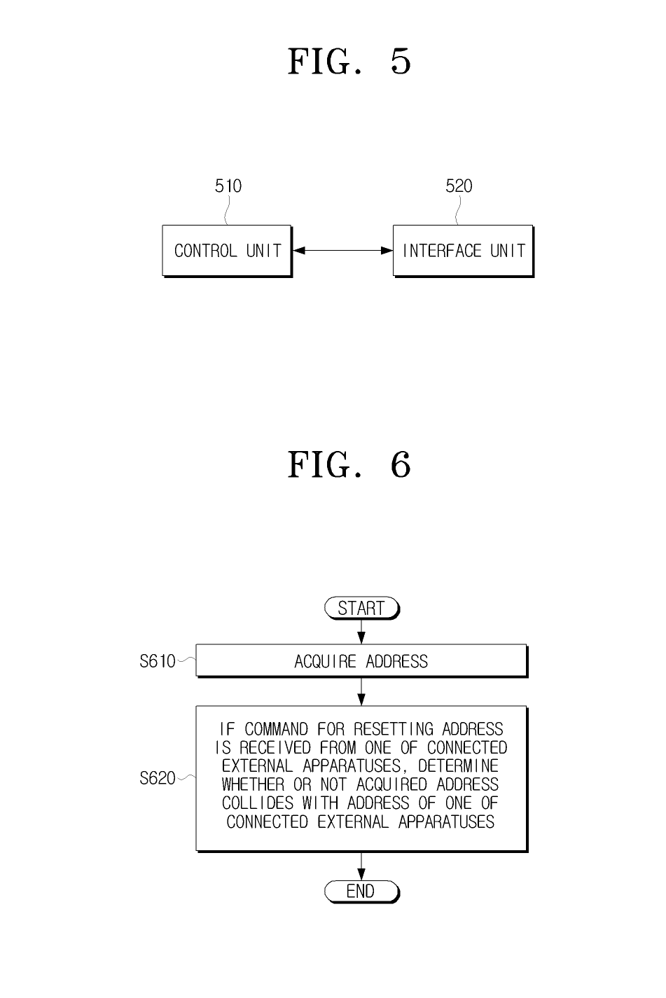

Hereinbelow, another exemplary embodiment of the present invention will be explained in detail with reference to FIGS. 5 and 6.

Referring to FIG. 5, a video apparatus according to another exemplary embodiment of the present invention may comprise a control unit 510, and an interface unit 520. The interface unit 520 is connected for communication with external apparatuses. The control unit 510 acquires its own address, and if a command for resetting an address from one of the external apparatuses which are connected through the interface 520 is received, the control unit 510 searches an external apparatus using the same address as its own address through the interface unit 520.

According to a method for managing an address as illustrated in FIG. 6, the video apparatus acquires an address at operation S610. If the video apparatus receives a command for resetting an address from one of the connected external apparatuses, it determines whether or not the acquired address and an address of one of the connected external apparatuses collide at operation S620.

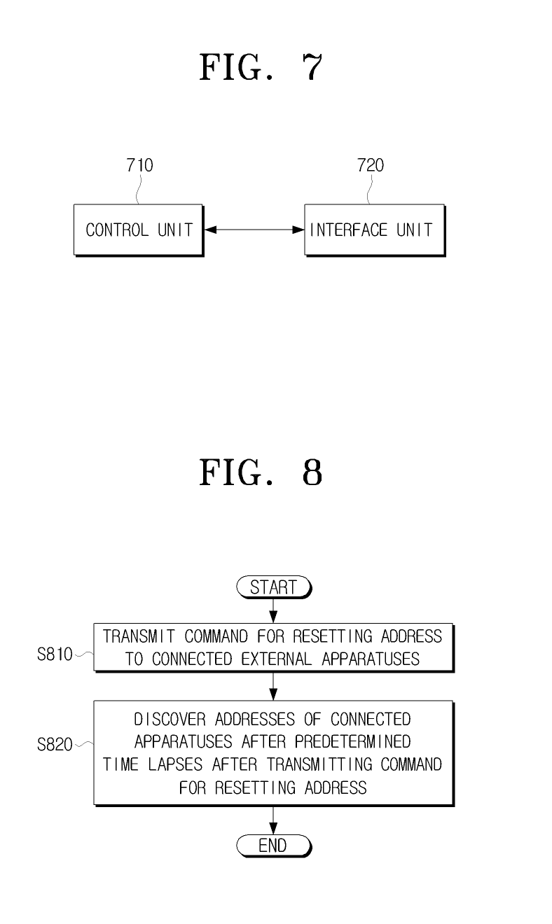

Yet another exemplary embodiment of the present invention will be explained in detail with reference to FIGS. 7 and 8.

Referring to FIG. 7, a video apparatus according to yet another exemplary embodiment of the present invention may comprise a control unit 710, and an interface unit 720. The interface unit 720 is connected for communication with external apparatuses. The control unit 710 transmits a command for resetting an address to external apparatuses which are connected through the interface 720, and acquires addresses of the external apparatuses which are connected through the interface 720 after a predetermined time lapses after transmitting the command for resetting the address.

According to a method for managing an address as illustrated in FIG. 8, the video apparatus transmits the command for resetting the address to the external apparatuses at operation S810. The video apparatus discovers addresses of the connected external apparatuses after a predetermined time lapses after transmitting the command for resetting an address at operation S820.

By doing so, an address management is possible using an address reset.

As described above, an address management is possible by an address reset thereby to prevent collision of addresses between AV apparatuses which may occur when an AV apparatus connected to a apparatus enters a power save mode, and another AV apparatus is connected to the apparatus.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method for managing an address of an apparatus comprising:
acquiring an address of the apparatus; and
determining whether or not the acquired address of the apparatus and an address of a first one of external apparatuses collide if a command for resetting an address is received from a second one of the external apparatuses.

2. The method of claim 1, further comprising:
changing the acquired address of the apparatus if an external apparatus using the same address as the acquired address among the external apparatuses is searched.

3. The method of claim 1, wherein the command for resetting an address comprises a command for determining whether or not the acquired address is used by any one of the external apparatuses.

4. The method of claim 3, wherein the command for resetting an address comprises information regarding a reason for performing the address reset.

5. The method of claim 1, wherein each of the addresses comprises a logical address.

6. The method of claim 1, wherein the external apparatuses are connected according to High Definition Multimedia Interface Consumer Electronics Control (HDMI CEC) standard.

7. A video apparatus comprising:
an interface which is connected for communication with external apparatuses; and
a control unit which acquires its own address, and searches an external apparatus using the same address as the acquired address among the external apparatuses through the interface if a command for resetting an address is received from one of the external apparatuses through the interface.

8. A method for managing an address comprising:
transmitting a command for resetting an address to external apparatuses; and
discovering addresses of the external apparatuses after a predetermined time lapses after the transmitting of the command for resetting an address.

9. The method of claim 8, wherein the command for resetting an address comprises a command for determining whether an address allocated to one of the external apparatuses is used by another one of the external apparatuses.

10. The method of claim 8, wherein the command for resetting an address comprises information regarding a reason for performing the address reset.

11. The method of claim 8, wherein each of the addresses comprises a logical address.

12. The method of claim 8, wherein the transmitting comprises broadcasting the command for resetting an address.

13. The method of claim 8, wherein the connected external apparatuses are connected according to High Definition Multimedia Interface Consumer Electronics Control (HDMI CEC) standard.

14. A video apparatus comprising:
an interfaces which is connected for communication with external apparatuses; and
a control unit which transmits a command for resetting an address to the external apparatuses through the interface, and discovers addresses of the external apparatuses through the interface after a predetermined time lapses after transmitting the command for resetting an address.
